(19) United States
(12) Patent Application Publication
(10) Pub. No.: US 2005/0032989 A1
(43) Pub. Date: Feb. 10, 2005

(54) HEAT-CURABLE ORGANOPOLYSILOXANE COMPOSITION AND ADHESIVE

(75) Inventors: Satosi Onai, Annaka-shi (JP); Hiroyasu Hara, Annaka-shi (JP); Akio Suzuki, Tano-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Shin-Etsu Chemical Co., Ltd., Tokyo (JP)

(21) Appl. No.: 10/910,654

(22) Filed: Aug. 4, 2004

(30) Foreign Application Priority Data
Aug. 5, 2003 (JP) 2003-206100

(51) Int. Cl. C08G 77/04

(52) U.S. Cl. 525/477

(57) ABSTRACT

A heat-curable organopolysiloxane composition comprising: (A) a diorganopolysiloxane with both molecular chain terminals blocked with hydroxyl groups,
(B) an organopolysiloxane resin comprising monofunctional siloxane units and SiO₂ units,
(C) a compound having two or more allyloxycarbonyl groups (CH₂═CHCH₂O(CO)—), an allyl group-containing isocyanurate compound, and/or an alkoxysilyl group-containing isocyanurate compound, and (D) a curing agent is provided. The composition is useful as an adhesive which has adequate pressure-sensitive adhesion (stickiness) to a substrate and which can be cured by short-time heat treatment to show strong adhesion. The adhesive is preferably provided in the form of a film.

### BACKGROUND OF THE INVENTION

1. Field of the Invention

The present invention relates to a heat-curable organopolysiloxane composition useful as an adhesive which is applied to various substrates to show adequate pressure-sensitive adhesion (stickiness), which is cured by heat treatment to produce strong adhesion, and which is preferably used, in particular, for the manufacture of a semiconductor device; to said adhesive; and to a semiconductor device.

2. Description of the Prior Art

Silicone-based pressure-sensitive adhesives are applied to various substrates and used for wide-range purposes in the same manner as silicone oils and silicone rubbers because the adhesives have characteristics such as heat resistance, cold resistance, electrical insulation property, weatherability, water resistance, and nontoxicity, derived from the polysiloxane structure thereof and further because the adhesives have excellent stickiness to fluororesins and silicone rubbers, which are difficult to adhere to using pressure-sensitive adhesives whose adhesive components are other organic polymers. The silicone-based pressure-sensitive adhesives are excellent particularly in characteristics such as high purity, high heat resistance, low Tg, low elastic modulus, high electrical resistance, and low dielectric constant and therefore preferably used for the manufacture of electronic components.

Conventional silicone-based pressure-sensitive adhesives are mainly used as protecting tapes, fixing tapes, and masking tapes and for purposes such as bonding substrates together. In these purposes, particularly high stickiness is not necessary. However, these adhesives are recently required not only to show good pressure-sensitive adhesion (stickiness) but also to have performances such as strong and permanent adhesion. For example, in particular, silicone-based adhesives having the aforementioned performances and being applicable as dicing tapes and die bonding tapes used in a manufacturing process for semiconductor devices are desired from the aspect of the reliability for the aforementioned characteristics derived from the polysiloxane structure, as described below.

Semiconductor devices are typically manufactured through a step of adhering a large-diameter silicon wafer to a dicing mount for wafer dicing under pressure with a dicing tape for fixation, a dicing step of processing the fixed silicon wafer into semiconductor chips by cutting the wafer in vertical and breadth directions, a step of releasing and separating the semiconductor chips from the dicing tape, and a step of adhering and fixing the semiconductor chips to a lead frame using a curable liquid adhesive (typically called die bonding agent), namely a die bonding step.

Recently, materials which combine a function of a dicing tape for sticking and fixing a silicon wafer and a function as a die bonding agent for adhering and fixing a semiconductor chip to a lead frame are desired particularly in the form of films, to simplify the steps and to avoid problems such as contamination of semiconductor parts by the liquid component when a liquid adhesive is used.

For example, the materials in the form of films need to resist the stress at the time of wafer cutting in the dicing step and to enable the secure sticking and retention so that the silicon wafer should not release from the dicing mount. In addition, the materials in the form of films need to have higher stickiness to the silicon wafer than stickiness to the dicing mount and to release from the dicing mount together with semiconductor chips when each semiconductor chip is separated after the dicing step. Then, in the die bonding step, the materials in the form of films need to retain adequate stickiness to fix the semiconductor chips onto the lead frame by adhesion under pressure. Furthermore, the materials need to have performances to strongly adhere and fix the semiconductor chips to the lead frame finally.

An adhesive composition comprising a polyimide-based resin has been proposed as a sheet for dicing and die bonding in Japanese Laid-open Patent publication (kokai) No. Hei 9-67558 (JP9-67558A) (Patent Reference 1). However, since the polyimide-based resin has high Tg and high elastic modulus, the composition inadequately relaxes the thermal stress between a semiconductor part and an adhered substrate, and lacks reliability. Accordingly, films for dicing and die bonding which comprises a silicone-based resin having low Tg and low elastic modulus and enabling stress relaxation has been required.

On the other hand, silicone-based pressure-sensitive adhesives having performances to change from a sticky state to a permanently adhesive state have also been proposed (see Patent References 2 to 4). These are room-temperature curable adhesives which are crosslinked and cured by the moisture in the air. Taking a long time from several days to several weeks to produce the desired high adhesion, they cannot be employed as either pressure-sensitive adhesives for dicing used for manufacturing the aforementioned semiconductor devices or pressure-sensitive adhesives for die bonding, from a viewpoint of productivity.

Recently, in many cases, substrates to which solder resist ink is applied are used as a lead frame on which semiconductor chips are mounted. It has been difficult for conventional die bonding agents to produce adequate adhesion performance to the substrates. Furthermore, silicone-based films for dicing and die bonding which impart adequate stickiness and adhesion strength to the substrates have not been obtained.

[Patent Reference 1]

Japanese Laid-open Patent publication (kokai) No. Hei 9-67558 (JP9-67558A)

[Patent Reference 2]

U.S. Pat. No. 5,302,671

[Patent Reference 3]

U.S. Pat. No. 5,905,123

[Patent Reference 4]

U.S. Pat. No. 5,340,887

### SUMMARY OF THE INVENTION

An object of the present invention is to provide a heat-curable organopolysiloxane composition useful as an adhesive which has adequate pressure-sensitive adhesion (stickiness) both to a substrate and a silicon wafer and to the substrate and a semiconductor chip in the dicing step and the die bonding step and which can strongly adhere and fix the semiconductor chip to a lead frame by short-time heat treatment in the die bonding step; and preferably an adhesive in the form of a film, in particular, an adhesive in the form of a film having a strong adhesion and not generating voids during heat curing.

The present inventors made extensive investigations to solve the aforementioned object. As a result, the present inventors have discovered that it is effective to use a heat-curable composition whose main component is a combination of a straight-chain organopolysiloxane and a network silicone resin to which an allyl group-containing compound and/or a compound having an isocyanurate structure is added. Based on this discovery, the present inventors have completed the present invention.

Thus, the present invention provides a heat-curable organopolysiloxane composition comprising:
(A) a diorganopolysiloxane with both molecular chain terminals blocked with hydroxyl groups,
(B) an organopolysiloxane resin comprising units represented by the formula: R¹₃SiO_{1/2} (wherein each R¹ independently represents a monovalent hydrocarbon group having 1 to 10 carbon atoms) and SiO₂ units in a molar ratio (units represented by the formula: R¹₃SiO_{1/2}/SiO₂ units) of 0.6 to 1.7,
(C) at least one compound selected from the group consisting of:
(i) a compound having two or more allyloxycarbonyl groups (CH₂═CHCH₂O(CO)—),
(ii) a compound represented by the general formula (1): 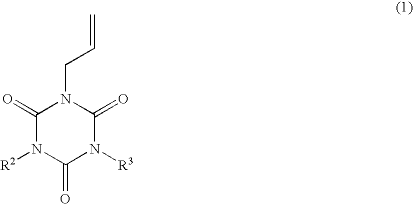
wherein each of R² and R³ independently represents an allyl group or a group represented by the general formula (2):
   —CH₂CH₂CH₂—SiR⁴ₐ(OR⁵)₃₋ₐ (2)
where each of R⁴ and R⁵ independently represents an unsubstituted or substituted monovalent hydrocarbon group, and a represents an integer from 0 to 2, and
(iii) a compound represented by the general formula (3): 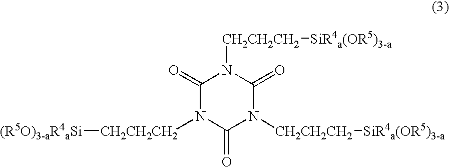
wherein R⁴, R⁵, and a are as defined for the general formula (2), and
(D) a curing agent;
   a pressure-sensitive and heat-curable adhesive comprising the composition; and a semiconductor device.

### BRIEF DESCRIPTION OF THE DRAWING

FIG. 1 is a schematic diagram of a test specimen used when the shear adhesion of a cured product of the present composition is measured.

### DETAILED DESCRIPTION OF THE PREFERRED EMBODIMENTS

The present invention will now be described below in detail. Herein, “Me” stands for a methyl group (—CH₃), and “Vi” stands for a vinyl group.

[Heat-Curable Organopolysiloxane Composition]

<Component (A)>

The component (A) of the present composition is a diorganopolysiloxane having hydroxyl groups at both molecular chain terminals. This diorganopolysiloxane is represented, for example, by the general formula: 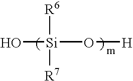
wherein each of R⁶ and R⁷ independently represents an unsubstituted or substituted monovalent hydrocarbon group, and m represents the number of repeating units which meet the conditions described blow.

Examples of the R⁶ and R⁷ include alkyl groups such as methyl groups, ethyl groups, propyl groups, butyl groups, pentyl groups, and hexyl groups; aryl groups such as phenyl groups, tolyl groups, and xylyl groups; halogenated alkyl groups such as chloromethyl groups and 3,3,3-trifluoropropyl groups; and alkenyl groups such as vinyl groups, allyl groups, butenyl groups, and pentenyl groups. Of these, methyl groups, vinyl groups, and phenyl groups are preferred.

In the case where an organic peroxide is used as a curing agent of the component (D) of the present composition, the component (A) that has alkenyl groups such as vinyl groups is preferably used. In the case where a combination of an organohydrogenpolysiloxane having two or more silicon atom-bonded hydrogen atoms within a molecule, which is a crosslinker, and a platinum-based catalyst is used as a curing agent of the component (D), it is necessary to use the component (A) that has at least two alkenyl groups such as vinyl groups within a molecule.

In either case, the quantity of the alkenyl group contained is typically 0.0005 to 0.1 mol and preferably 0.001 to 0.05 mol based on 100 g of the diorganopolysiloxane of the component (A).

The component (A) may be either oily or crude rubber-like. In the case of being oily, the component (A) has a viscosity at 25° C. of typically 50 mPa·s or more and preferably 100 mPa·s or more. If the viscosity is too low, the stickiness of the present composition may lower.

In the case of being crude rubber-like, the component (A) has a viscosity at 25° C. of 100,000 mPa·s or less and preferably 75,000 mPa·s or less in a 30% by weight toluene solution thereof. If the viscosity of the solution is too high, the viscosity of the present composition becomes too high. As a result, operations such as stirring and mixing in manufacturing the composition may become difficult, and it may become difficult to shape the composition in the form of a film.

The component (A) that is crude rubber-like is preferred for the present composition to be rich in stickiness.

Preferred specific examples of the diorganopolysiloxane of the component (A) include a compound represented by the structural formula: 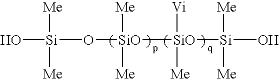
wherein p is a number of 100 or more, q is a number of 0 or more, p+q is such a number that the viscosity at 25° C. of a 30% by weight toluene solution of this diorganopolysiloxane is 42,000 mPa·s, and q is such a number that the quantity of the Vi is 0.002 mol based on 100 g of this diorganopolysiloxane.

The diorganopolysiloxane of the component (A) may be used singularly, or in combination of two or more.

<Component (B)>

The component (B) of the present composition is an organopolysiloxane resin comprising units represented by the formula: R¹₃SiO_{1/2} (wherein each R¹ independently represents an unsubstituted or substituted monovalent hydrocarbon group having 1 to 10 and preferably 1 to 6 carbon atoms), namely monofunctional siloxane units (hereinafter referred to as “M units”), and SiO₂ units, namely tetrafunctional siloxane units (hereinafter referred to as “Q units”), in a molar ratio of M units/Q units of 0.6 to 1.7 and preferably 0.6 to 1.0.

If the molar ratio of both the units is less than 0.6, the stickiness and tackiness of a pressure-sensitive adhesive comprising the present composition may lower. On the other hand, if the molar ratio exceeds 1.7, the stickiness may also lower and the force to retain the stuck and fixed object may lower.

Examples of the R¹ include alkyl groups such as methyl groups, ethyl groups, propyl groups, and butyl groups; cycloalkyl groups such as cyclohexyl groups; aryl groups such as phenyl groups; and alkenyl groups such as vinyl groups, allyl groups, and hexenyl groups. Of these, methyl groups are preferred.

The organopolysiloxane resin of the component (B) may have silicon atom-bonded hydroxyl groups (silanol groups). The quantity of the hydroxyl groups contained is 0 to 4.0% by weight. If the quantity exceeds 4.0% by weight, the heat-curability of an adhesive comprising the present composition may undesirably lower. Furthermore, as long as the object and effects of the present invention do not deteriorate, the component (B) may have a relatively small quantity of trifunctional units represented by the formula: R¹SiO_{3/2} and/or bifunctional units represented by the formula: R¹₂SiO (in each of the formulas, R¹ is as defined above).

Preferred specific examples of the component (B) include an organopolysiloxane resin comprising SiO₂ units and (CH₃)₃SiO_{1/2} units in a ratio of 0.75 mol:1 mol and containing 1.0% by weight of hydroxyl groups.

The organopolysiloxane resin of the component (B) may be used singularly, or in combination of two or more.

When the components (A) and (B) are used, both the components may merely be added to the present composition. If the component (B) has hydroxyl groups, both the components may be added as partial condensation products by subjecting the two to a condensation reaction using a known method. To conduct the condensation reaction, both the components may dissolved and mixed in a solvent such as toluene, which can dissolve both the components, and a reaction may proceed using a basic catalyst such as ammonia or an alkaline catalyst at room temperature to reflux temperature.

To make the present composition sticky, the weight ratio of the component (A)/the component (B) is typically 30˜70/70˜30 (i.e., 30/70 to 70/30) and preferably 40/60 to 60/40.

<Component (C)>

The component (C) of the present composition is a component added so that a cured product obtained by the heat treatment of the present composition used as an adhesive greatly improves in the pressure-sensitive adhesion or stickiness to a substrate.

As the component (C), at least one compound selected from the group consisting of the compounds (i), (ii), and (iii) described below is used.
(i) a compound having two or more allyloxycarbonyl groups (CH₂═CHCH₂O(CO)—)

Preferred examples of the component (i) include a compound represented by the general formula (4): 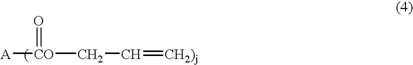
wherein A is a divalent to tetravalent group selected from the group consisting of —CH═CH—, —CH₂CH₂—, 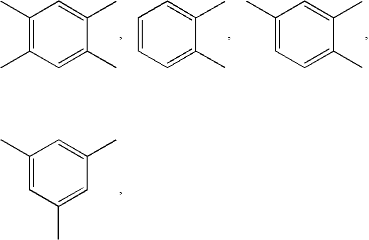 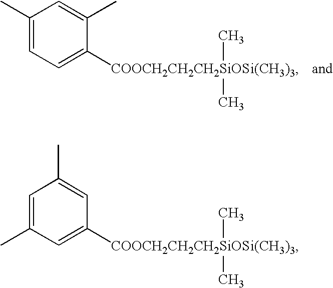
and j represents the valence number of the group A;
a compound represented by the general formula (5): 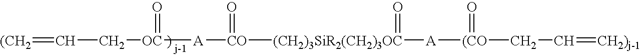
wherein each R independently represents an unsubstituted or substituted monovalent hydrocarbon group having preferably 1 to 6 and more preferably 1 to 3 carbon atoms, and each of A and j is independently as defined for the general formula (4); or a combination of the compound represented by the general formula (4) and the compound represented by the general formula (5).

Examples of the R in the general formula (5) include the groups as exemplified for the R⁶ and R⁷. Of these, methyl groups are preferred.

Preferred specific examples of the compound represented by the general formula (4) include the compounds represented by the structural formulas described below.

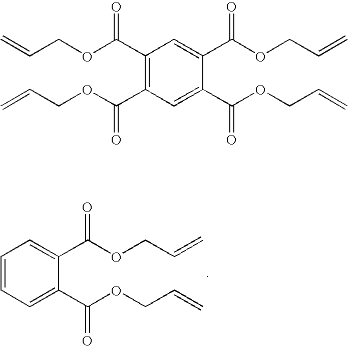

Preferred specific examples of the compound represented by the general formula (5) include the compounds represented by the structural formulas described below. 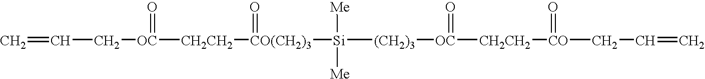
(ii) a compound represented by the general formula (1): 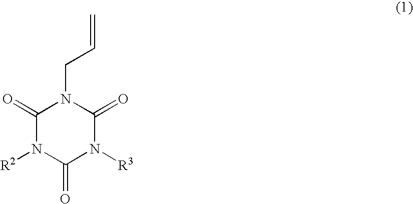
wherein each of R² and R³ independently represents an allyl group or a group represented by the general formula (2):
   —CH₂CH₂CH₂—SiR⁴ₐ(OR⁵)₃₋ₐ (2)
where each of R⁴ and R⁵ independently represents an unsubstituted or substituted monovalent hydrocarbon group, and a represents an integer from 0 to 2.

Examples of the R⁴ and R⁵ in the general formula (2) related to the component (ii) include the groups as exemplified for the R⁶ and R⁷. Of these, methyl groups and ethyl groups are preferred.

If both the R² and R³ are allyl groups, the component (ii) is triallyl isocyanurate. The component (ii) in which the R² and/or R³ is represented by the general formula (2): —CH₂CH₂CH₂—SiR⁴ₐ(OR⁵)₃₋ₐ can be obtained by adding 1 mol or 2 mol of a compound having one silicon atom-bonded hydrogen atom represented by the formula: HR⁴ₐSi(OR⁵)₃₋ₐ, wherein R⁴, R⁵, and a are as defined above, to 1 mol of triallyl isocyanurate by the known hydrosilylation reaction in the presence of platinum-based catalyst.

Preferred specific examples of the component (ii) include the compounds represented by the structural formulas described below. 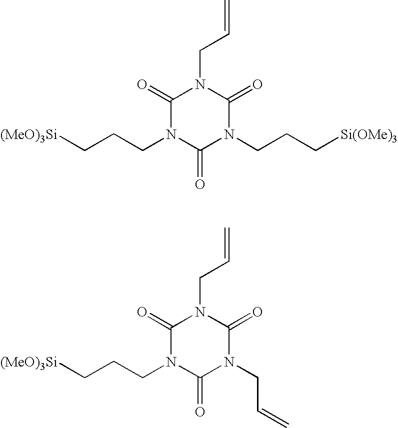
(iii) a compound represented by the general formula (4): 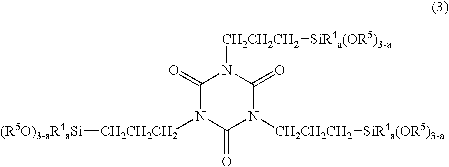
wherein R⁴, R⁵, and a are as defined for the general formula (2).

The component (iii) can be obtained by adding 3 mol of a compound having one silicon atom-bonded hydrogen atom represented by the formula: HR⁴ₐSi(OR⁵)₃₋ₐ, wherein R⁴, R⁵, and a are as defined above, to 1 mol of triallyl isocyanurate by the known hydrosilylation reaction in the presence of platinum-based catalyst.

Preferred specific examples of the component (iii) include the compounds represented by the structural formulas described below.

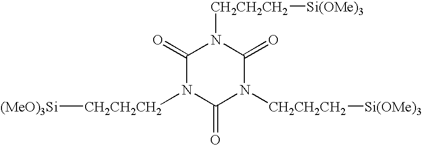

As described above, the component (C) may be used singularly, or in combination of two or more.

The quantity of the component (C) added is typically 0.2 to 20 parts by weight and preferably 1 to 10 parts by weight based on 100 parts by weight of the combined quantity of the components (A) and (B) to improve the adhesion of a cured product of the present composition as described above and not to cause adverse effects on storage stability over time.

<Component (D)>

A curing agent of the component (D) is a component added so that, after molded into a desired form, the present composition is cured by a heat treatment-induced crosslinking reaction.

In the present invention, an organic peroxide is preferably used as the component (D). In this case, free radicals generated by the heat decomposition of the organic peroxide induce the linkage reactions among the silicon atom-bonded hydrocarbon groups in the components (A) to (C) or among the alkenyl groups such as vinyl groups and allyl groups in the components (A) to (C) to produce a crosslinked cured product.

All the known organic peroxides used for radical polymerization reactions can be used. Examples thereof include benzoyl peroxide, bis(3-methylbenzoyl) peroxide, bis(4-methylbenzoyl) peroxide, 2,4-dichlorobenzoyl peroxide, p-chlorobenzoyl peroxide, dicumyl peroxide, bis(t-butyl) peroxide, 2,5-dimethyl-2,5-bis(t-butylperoxy)hexane, and t-butyl cumyl peroxide. The quantity of the organic peroxide added is typically 0.1 to 10 parts by weight and preferably 0.5 to 5 parts by weight based on 100 parts by weight of the combined quantity of the components (A) and (C).

Moreover, if the component (A) has at least two alkenyl groups, an addition reaction-type curing agent in which an organohydrogenpolysiloxane having two or more silicon atom-bonded hydrogen atoms is combined with a platinum-based catalyst can be used as the component (D). In this case, the organohydrogenpolysiloxane functions as a crosslinker. In the presence of the platinum-based catalyst, the alkenyl groups such as vinyl groups and allyl groups in the components (A) to (C) undergo addition to the silicon atom-bonded hydrogen atoms by the hydrosilylation reaction to form crosslinkages and to produce a cured product.

The structure of the organohydrogenpolysiloxane having two or more silicon atom-bonded hydrogen atoms may be straight, cyclic, or branched. Specific examples thereof include the compounds represented by the structural formulas described below.

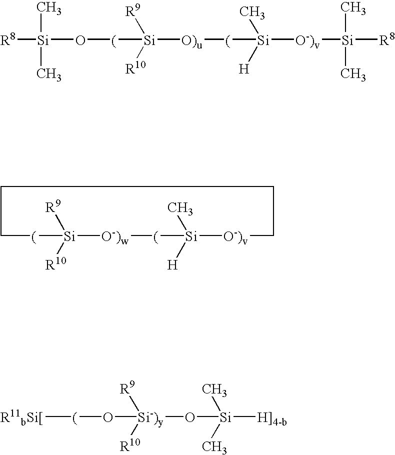

(In each of the formulas, R⁸ represents a hydrogen atom or a monovalent hydrocarbon group having preferably 1 to 6 and more preferably 1 to 3 carbon atoms except an alkenyl group, each of R⁹, R¹⁰, and R¹¹ independently represents a monovalent hydrocarbon group having preferably 1 to 6 and more preferably 1 to 3 carbon atoms except an alkenyl group, u represents an integer from 0 to 500, v represents an integer from 2 to 500, x represents an integer from 2 to 6, w represents an integer from 0 to 4, y represents an integer from 0 to 300, and b represents an integer from 0 to 2.)

Examples of the monovalent hydrocarbon groups of the R⁸ to R¹¹ include alkyl groups such as methyl groups, ethyl groups, and propyl groups; and aryl groups such as phenyl groups, tolyl groups, and xylyl groups. Of these, methyl groups and phenyl groups are preferred, and methyl groups are particularly preferred.

More specific examples of the organohydrogenpolysiloxane include dimethylpolysiloxane with both molecular chain terminals blocked with dimethylhydrogensiloxy groups, methylphenylpolysiloxane with both molecular chain terminals blocked with dimethylhydrogensiloxy groups, copolymers of dimethylsiloxane and methylhydrogensiloxane with both molecular chain terminals blocked with dimethylhydrogensiloxy groups, copolymers of dimethylsiloxane and methylphenylsiloxane with both molecular chain terminals blocked with dimethylhydrogensiloxy groups, methylhydrogenpolysiloxane with both molecular chain terminals blocked with trimethylsiloxy groups, copolymers of dimethylsiloxane and methylhydrogensiloxane with both molecular chain terminals blocked with trimethylsiloxy groups, copolymers of dimethylsiloxane, methylhydrogensiloxane, and methylphenylsiloxane with both molecular chain terminals blocked with trimethylsiloxy groups, 1,3,5,7-tetramethylcyclotetrasiloxane, and 1,3,5,7,9-pentamethylcyclopentasiloxane.

This organohydrogenpolysiloxane is present such that the quantity of the silicon atom-bonded hydrogen atoms in this component is typically 0.2 to 30 mol and preferably 0.5 to 10 mol based on 1 mol of the combined quantity of the alkenyl groups such as vinyl groups and allyl groups in the components (A) to (C) of the present invention.

Examples of the platinum-based catalyst include chloroplatinic acid, alcohol-modified chloroplatinic acid, an olefin complex of platinum, a complex of platinum with vinylsiloxanes, platinum black, and solid platinum supported on carriers such as alumina and silica. The quantity of the platinum-based catalyst added is typically 0.1 to 1000 ppm and particularly 1 to 500 ppm in terms of platinum metal atoms in the platinum-based catalyst, based on the combined weight of the component (A), the component (B) in the case where the component (B) has alkenyl groups, the component (C) in the case where the component (C) has allyl groups, and the organohydrogenpolysiloxane.

In the present invention, the organic peroxide and the organohydrogenpolysiloxane and platinum-based catalyst can be further combined and used as a curing agent of the component (D). In this case, crosslinking reactions by free radicals and addition reactions of the alkenyl groups such as vinyl groups and allyl groups with the silicon atom-bonded hydrogen atoms in the organohydrogenpolysiloxane concurrently proceed to produce a cured product.

In the case where the combination of the organohydrogenpolysiloxane having two or more silicon atom-bonded hydrogen atoms and the platinum-based catalyst is used as the curing agent of the component (D), addition of a suitable quantity of a reaction retarding agent is effective to retard the progress of the hydrosilylation reaction under temperature conditions at the time of storage or transport and to ensure a pot life adequate from a viewpoint of workability. Specific examples of the reaction retarding agent include acetylene alcohol compounds such as 3-methyl-1-butyn-3-ol and 1-ethynyl-1-cyclohexanol, nitrogen-containing compounds, sulfur-containing compounds, and phosphorus-containing compounds.

<Other Components>

In addition to the components (A) to (D) and the optionally used reaction retarding agent, other components may be added to the present composition where necessary as long as the object and effects of the present invention do not deteriorate.

To facilitate operations such as application and molding when the present composition is used as an adhesive, an organic solvent can be added as a diluting agent. Examples of the organic solvent include toluene, xylene, hexane, heptane, ethanol, isopropyl alcohol, acetone, and methyl ethyl ketone. If the organic solvent is used, the quantity used may be adjusted according to a desired viscosity of the resulting diluted product. The quantity is typically 20 to 80 parts by weight and preferably 30 to 70 parts by weight based on 100 parts by weight of the combined quantity of the components (A) to (D) and the optionally used reaction retarding agent.

A variety of adhesion auxiliary agents can be added to increase the stickiness of the present composition and the adhesion of a cured product obtained after the heat treatment of the present composition.

Examples of the adhesion auxiliary agent include silane compounds such as vinyltrimethoxysilane, vinylmethyldimethoxysilane, vinyltriethoxysilane, acryloxypropyltrimethoxysilane, acryloxypropylmethyldimethoxysilane, acryloxypropyltriethoxysilane, methacryloxypropyltrimethoxysilane, methacryloxypropylmethyldimethoxysilane, methacryloxypropyltriethoxysilane, glycidoxypropyltrimethoxysilane, and glycidoxypropyltriethoxysilane. In addition, examples of the adhesion auxiliary agent also include the siloxane compounds represented by the structural formulas described below. 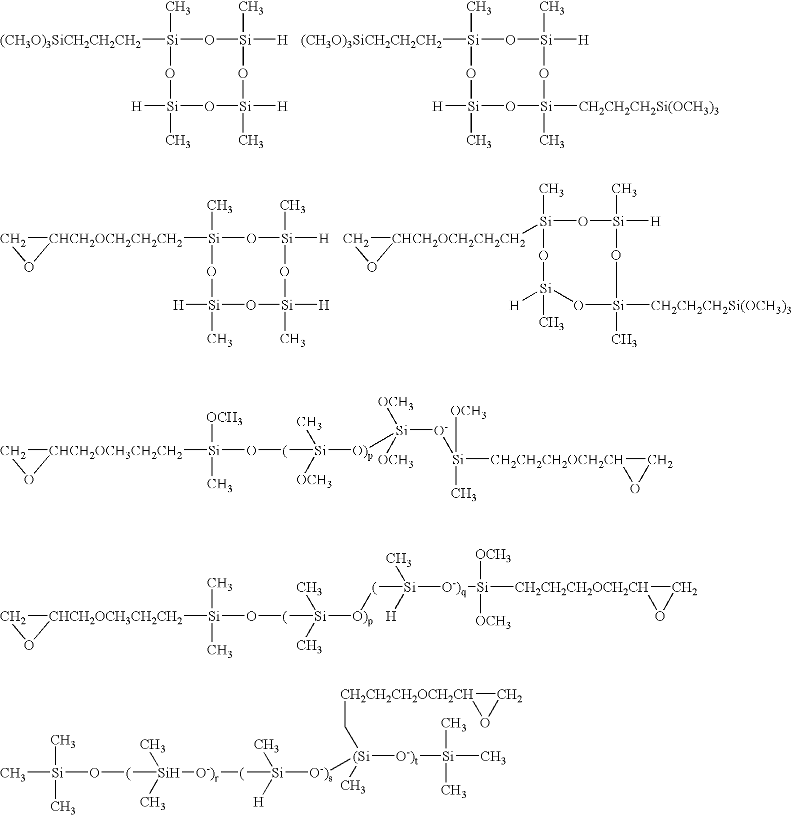
(In each of the formulas, each of p and r represents an integer from 0 to 50, and each of q, s, and t represents an integer from 1 to 50.)

When an addition reaction-type curing agent is used as the component (D), the siloxane compounds having two or more silicon atom-bonded hydrogen atoms substantially functions as crosslinking agents together with and in the same manner as the aforementioned organohydrogenpolysiloxane.

The adhesion auxiliary agent may be used singularly, or in combination of two or more.

If the adhesion auxiliary agent is used, the quantity added varies with the type of a curing agent used. The quantity is typically 0.2 to 20 parts by weight and preferably 1 to 10 parts by weight based on 100 parts by weight of the combined quantity of the components (A) to (D) and the optionally used reaction retarding agent.

Besides, fillers such as silica fine particles, alumina fine particles, titanium oxide, carbon black, and conductive particles; coloring agents such as inorganic or organic pigments and dyes; and additives such as wettability-improving agents may be suitably added according to various purposes.

[Pressure-Sensitive and Heat-Curable Adhesive]

In the uncured state, the present composition can be used as a pressure-sensitive adhesive and shows good stickiness to various substrates. Accordingly, for example, in a dicing step in the manufacture of a semiconductor device, the present composition is applied to a dicing mount and can be effectively used as a sticking material for temporarily fixing a silicon wafer.

The present composition can also be used as an adhesive which produces, by heat treatment, a cured product showing strong adhesion. Accordingly, for example, in a die bonding step in the manufacture of a semiconductor device, a semiconductor chip integrally having a sticky layer comprising the uncured adhesive is adhered to a lead frame under pressure and then heat-treated. Thereby, a semiconductor device in which a substrate and the semiconductor chip are strongly connected through a cured layer of the adhesive of the present invention can be manufactured.

The adhesive of the present invention can also be used sequentially in both the dicing step and die bonding step in a process for manufacturing a semiconductor.

[Use as an Adhesive]

(1) First, a coating method is exemplified as a method for applying the adhesive of the present invention. In the coating method, the adhesive of the present invention is applied onto a target substrate. If the adhesive contains a volatile solvent, the solvent is removed by drying. An adhesive layer is formed to have a given thickness. Another substrate is adhered to the adhesive layer under pressure and is stuck and fixed thereon. The stuck and fixed substrate is subjected to required steps such as cutting. As necessary, heat treatment is conducted in the same or another process to form a cured adhesive layer.

(2) The pressure-sensitive and curable adhesive of the present invention can be used in the form of a film. In this case, it is in the same form as a known hot-melt adhesive film.

When the adhesive of the present invention is formed into a film, it is preferable to use a release film such as a film of polyethylene, polypropylene, polyester, polyamide, polyimide, polyamideimide, polyetherimide, and polytetrafluoroethylene, paper, and metal foil as an auxiliary material.

For example, first, the adhesive of the present invention is applied onto a release film as described for the coating method. If the adhesive contains a volatile solvent, the solvent is removed by drying. An adhesive layer is formed to have a given thickness. Thus, an adhesive in the form of a two-layer structure film in which the adhesive layer is superposed and supported on the release film can be obtained. As necessary, another release film may be adhered onto the adhesive layer under pressure to produce an adhesive in the form of a three-layer structure. Furthermore, the adhesive in the form of a film may be formed into a long tape. Thereby, the adhesive can be wound in the form of a roll, and workability can be improved in a process for using the adhesive in the form of a film.

When the adhesive in the form of a two-layer structure film is used, the adhesive side is adhered to a target substrate under pressure. Then, the release layer is removed, and another substrate is adhered to the other adhesive side under pressure and is stuck and fixed. When the adhesive in the form of a three-layer structure film is used, the release layer on one side is removed, and the adhesive side is adhered to a target substrate under pressure. Then, the release layer on the other side is removed, and another substrate is adhered to the other adhesive side under pressure and is stuck and fixed. The subsequent steps are as described for the coating method.

(3) When the adhesive layer of the present invention is formed as described above, its thickness can be set with no particular restrictions according to a purpose and is typically 0.01 to 2.0 mm and preferably 0.01 to 1.0 mm.

When a composition diluted with a solvent is used for forming an adhesive layer, conditions for drying and removing the solvent vary with a given thickness of the adhesive layer. The drying and removing are conducted typically at room temperature for 2 or more hours or at 40 to 130° C. for 1 to 20 minutes and particularly preferably at 50 to 120° C. for 1 to 20 minutes. However, it is preferable that the conditions are as mild as possible. If the temperature is too high or the heating time is too long, the alkenyl groups such as the silicon atom-bonded vinyl groups and allyl groups in the components (A) to (C) are reacted with one another, and the stickiness or heat adhesion may deteriorate. As long as an initial adhesion is maintained, the adhesive layer may be crosslinked to some extent.

To prevent voids (holes) from being generated in the cured product of the adhesive of the present invention in the heat-curing step, the quantity of the volatile component in the adhesive layer is preferably less than 1% by weight.

To produce a structure in which a first substrate and a second substrate made of a material that is the same as or different from that of the first substrate are strongly adhered and semipermanently connected through a cured layer of the adhesive of the present invention, a heat-induced adhering is conducted under such conditions that a curing agent of the component (D) effectively produces curing performance. The heat-induced adhering is conducted typically at 100 to 250° C. for 15 to 60 minutes and particularly preferably at 120 to 230° C. for 15 to 60 minutes.

Examples of substrates for which the adhesive of the present invention can produce excellent performances in stickiness and heat curing-induced adhesion include metal substrates of Fe, Al, Cr, Ni, Si, Cu, Ag, and Au; inorganic or ceramic substrates of glass, silicon nitride, and silicon carbide; and organic substrates of epoxy resin, Bakelite, polyimide, polyamide, polyester, and silicone resin.

[Semiconductor Device]

Reliable semiconductor devices can be manufactured with high productivity by using the adhesive of the present invention in the form of a film, particularly in the form of a three-layer film, to the dicing step and die bonding step. Examples of the manufacturing process are described below, although the present invention is not restricted thereto.

First, a dicing mount having adequate stickiness on one side on which a silicon wafer is mounted is prepared. The present adhesive in the form of a film having release layers on both sides is cut into the shape corresponding to the dicing mount, is superposed exactly on the dicing mount, and is stuck and fixed. The release layer on the side to which the dicing mount is not stuck is then released and removed. Subsequently, a silicon wafer is adhered to the exposed adhesive layer under pressure and is stuck and fixed. Then, the silicon wafer is diced.

After dicing, the semiconductor chips obtained are separated. At this time, the adhesive layer is easily released from the release layer on the dicing mount and separated together with the semiconductor chips. Thus, the semiconductor chips having the adhesive layer on one side can be obtained.

Subsequently, the semiconductor chips are adhered to a prepared lead frame through the adhesive layer under pressure and are stuck and fixed thereto. Finally, the structure comprising the semiconductor chips, the adhesive layer, and the lead frame is heat-treated as required, and the adhesive layer is cured to adhere the semiconductor chips to the lead frame.

Thus, semiconductor devices in which the substrate and the semiconductor chips are strongly connected through a cured layer of the adhesive of the present invention can be manufactured with high productivity.

### EXAMPLES

As follows is a specific description of the present invention, although the present invention is not restricted thereto. Hereinafter, “parts” means parts by weight.

### Preparation Example 1

50 parts of (A) a crude rubber-like dimethylpolysiloxane with both molecular chain terminals blocked with hydroxyl groups, the dimethylpolysiloxane having a viscosity at 25° C. of 42,000 mPa·s in a 30% by weight toluene solution thereof and having 0.002 mol of vinyl groups based on 100 g thereof and 50 parts of (B1) a methylpolysiloxane resin comprising (CH₃)SiO_{1/2} units and SiO₂ units in a molar ratio of (CH₃)SiO_{1/2} units/SiO₂ units of 0.75 were dissolved in 100 parts of toluene. Hereinafter, this toluene solution is referred to as (AB-1)

### Preparation Example 1

50 parts of (A) a crude rubber-like dimethylpolysiloxane with both molecular chain terminals blocked with hydroxyl groups, the dimethylpolysiloxane having a viscosity at 25° C. of 42,000 mPa·s in a 30% by weight toluene solution thereof and 50 parts of (B2) a methylpolysiloxane resin comprising (CH₃)SiO_{1/2} units and SiO₂ units in a molar ratio of (CH₃)SiO_{1/2} units/SiO₂ units of 0.75 and containing 1.0% by weight of the hydroxyl groups were dissolved in 100 parts of toluene. 0.5 parts of 28% by weight aqueous ammonia was added to this toluene solution. The resulting solution was stirred at room temperature for 16 hours and underwent a condensation reaction. Then, the solution was heated at 120 to 130° C., and the water produced by the condensation was removed together with toluene as an azeotrope to produce a partial condensation product.

100 parts of the partial condensation product obtained Hereinafter, this toluene solution is referred to as (AB-2).

### Example 1

Adhesive Liquid 1 was prepared by mixing 100 parts of the (AB-2), 1.6 parts of (C1) a compound represented by the following structural formula (6): TRIAM-805 (brand name, manufactured by Wako Pure Chemical Industries, Ltd.), and 0.8 parts of (D1) bis(3-methylbenzoyl) peroxide.

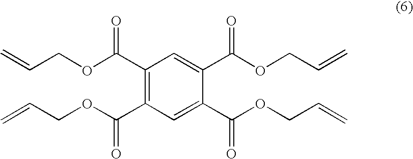

### Example 2

Adhesive Liquid 2 was prepared by mixing 100 parts of the (AB-2), 1.6 parts of (C1) the compound represented by the structural formula (6), 0.8 parts of (C2) a compound represented by the following structural formula (7), and 0.8 parts of (D1) bis(3-methylbenzoyl) peroxide.

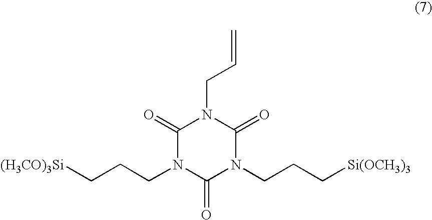

### Example 3

Adhesive Liquid 3 was prepared by mixing 100 parts of the (AB-2), 1.6 parts of (C2) the compound represented by the structural formula (7), and 0.8 parts of (D1) bis(3-methylbenzoyl) peroxide.

### Example 4

Adhesive Liquid 4 was prepared by mixing 100 parts of the (AB-1), 1.6 parts of (C1) the compound represented by the structural formula (6), a combination of 1.29 parts of (D2) an organohydrogenpolysiloxane represented by the following structural formula (8) and a solution of 2-ethylhexanol-modified chloroplatinic acid (in a quantity of 10 ppm in terms of platinum metal atoms, based on the combined weight of the solid content in the (AB-1), the (C1), and the organohydrogenpolysiloxane), and 0.05 parts of 3-methyl-1-butyn-3-ol.

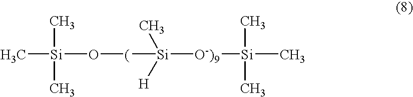

### Example 5

Adhesive Liquid 5 was prepared by mixing 100 parts of the (AB-1), 1.6 parts of (C2) the compound represented by the structural formula (7), a combination of 1.29 parts of (D2) the organohydrogenpolysiloxane represented by the structural formula (8) and a solution of 2-ethylhexanol-modified chloroplatinic acid (in a quantity of 10 ppm in terms of platinum metal atoms, based on the combined weight of the solid content in the (AB-1), the (C2), and the organohydrogenpolysiloxane), and 0.05 parts of 3-methyl-1-butyn-3-ol.

### Example 6

Adhesive Liquid 6 was prepared by mixing 100 parts of the (AB-1), 1.6 parts of (C1) the compound represented by the structural formula (6), 0.8 parts of (D1) bis(3-methylbenzoyl) peroxide, the combination of 1.29 parts of (D2) the organohydrogenpolysiloxane represented by the structural formula (8) and the solution of 2-ethylhexanol-modified chloroplatinic acid (in a quantity of 10 ppm in terms of platinum metal atoms, based on the combined weight of the solid content in the (AB-1), the (C1), and the organohydrogenpolysiloxane), and 0.05 parts of 3-methyl-1-butyn-3-ol.

### Example 7

Adhesive Liquid 7 was prepared by mixing 100 parts of the (AB-1), 1.6 parts of (C1) the compound represented by the structural formula (6), 0.8 parts of (C3) a compound represented by the following structural formula (9), and 0.8 parts of (D1) bis(3-methylbenzoyl) peroxide.

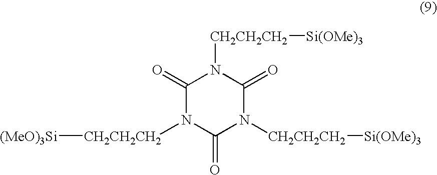

### Example 8

Adhesive Liquid 8 was prepared by mixing 100 parts of the (AB-2), 1.6 parts of (C3) the compound represented by the structural formula (9), and 0.8 parts of (D1) bis(3-methylbenzoyl) peroxide.

### Comparative Example 1

Adhesive Liquid 9 was prepared in the same manner as Example 1, except that the component (C1) described in Example 1 was not used.

<Measurement of Adhesion>

The adhesive liquids prepared in Examples and Comparative Examples were applied to one side of PET films with a thickness of 50 μm coated with a fluorine-containing silicone-based release agent and allowed to stand at room temperature for 10 minutes, followed by heat treatment at 80° C. for 10 minutes to form adhesive layers with a thickness of about 50 μm. The PET films with adhesive layers formed thereon were then cut into a shape of 25 mm in length and 10 mm in width to produce test pieces.

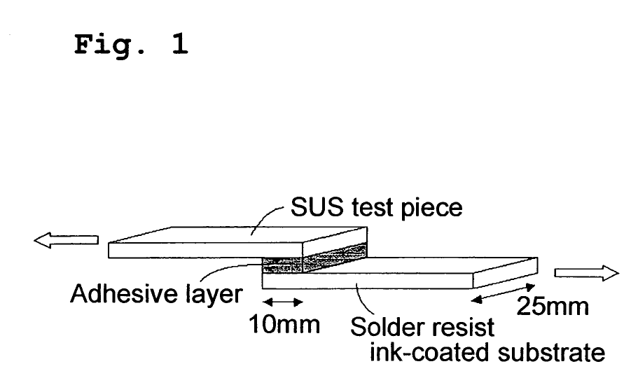

As shown in FIG. 1, the adhesive layer side of the test piece was bonded to the end of an SUS test piece of 25 mm in width. The PET film was then released and removed. On the adhesive layer side exposed by removing the PET film, was superimposed one end of a unit substrate of 25 mm in width comprising a BT resin to which a UV-curable solder resist ink (brand name: PSR4000 AUS308, manufactured by Taiyo Ink MFG. Co., Ltd.) was applied. The end of the SUS test piece, the adhesive layer, and the unit substrate were adhered under pressure by applying a load of 2000 gf for 1 minute to the position where these three were overlapped, and a test specimen was obtained.

Subsequently, the test specimen is placed in a heating furnace and heated at 1500° C. for 60 minutes, and the adhesive layer was cured. The test specimen was then pulled by applying a load in both the directions shown by the arrows in FIG. 1 using a shear adhesion-measuring device, and the shear adhesion (kg/cm²) was measured. In addition, the state of the adhesive layer is observed by eye after the measurement.

Results of the measurement and the observation are shown in Table 1.

TABLE 1

| | | | | | | | | | Comparative |
|---|---|---|---|---|---|---|---|---|---|
| | Example | | | | | | | | Example |
| | 1 | 2 | 3 | 4 | 5 | 6 | 7 | 8 | 1 |
| Adhesive | 1 | 2 | 3 | 4 | 5 | 6 | 7 | 8 | 9 |
| Liquid | | | | | | | | | |
| No. | | | | | | | | | |
| (C) | (6) | (6) + | (7) | (6) | (7) | (6) | (6) + | (9) | None |
| Adhesion | | (7) | | | | | (9) | | |
| improving | | | | | | | | | |
| agent(s) * | | | | | | | | | |
| (D) | Peroxide | | | Addition | | Peroxides + | Peroxide | | |
| Curing | | | | reaction- | | Addition | | | |
| agent(s) | | | | type | | reaction- | | | |
| | | | | curing | | type | | | |
| | | | | agent | | curing | | | |
| | | | | | | agent | | | |
| Shear | 80.5 | 88.0 | 81.3 | 20.1 | 22.0 | 48.2 | 75.0 | 86.0 | 16.5 |
| adhesion | | | | | | | | | |
| (kg/cm²) | | | | | | | | | |

| | | | | |
|---|---|---|---|---|
| State of | Overall cohesive | Partial cohesive | Overall | No cohesive |
| peeling | failure | failure | cohesive | failure |
| | | | failure | |

* (6):

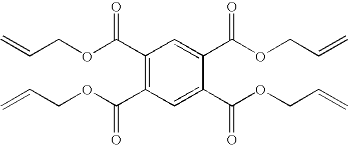

* (7):

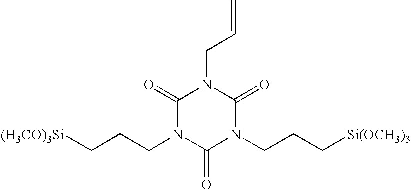

* (9):

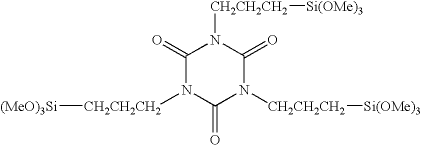

[Effects of the Invention]

The heat-curable organopolysiloxane composition of the present invention has excellent effects as a pressure-sensitive adhesive having excellent stickiness and as a heat-curable adhesive showing strong adhesion. In particular, in the manufacture of a semiconductor device, the composition enables adhesion under pressure and fixation of a substrate such as a silicon wafer and the secure performance of the substrate-cutting (dicing) step. The composition also enables semiconductor chips to adhere to a substrate. The composition can strongly adhere particularly to a substrate to which solder resist ink is applied. The composition does not generate voids at the time of curing and molding. The composition is easy to handle because it can be supplied in the form of a film. Unlike liquid adhesives, the composition does not cause any contamination of peripheral parts by the fluid component. Accordingly, the pressure-sensitive and heat-curable adhesive in the form of a film comprising the composition of the present invention can be preferably used as dicing and die bonding tapes.

1. A heat-curable organopolysiloxane composition comprising:
(A) a diorganopolysiloxane with both molecular chain terminals blocked with hydroxyl groups,
(B) an organopolysiloxane resin comprising units represented by the formula: R¹₃SiO_{1/2} (wherein each R¹ independently represents a monovalent hydrocarbon group having 1 to 10 carbon atoms) and SiO₂ units in a molar ratio of units represented by the formula: R¹₃SiO_{1/2}/SiO₂ units of 0.6 to 1.7,
(C) at least one compound selected from the group consisting of:
(i) a compound having two or more allyloxycarbonyl groups (CH₂═CHCH₂O(CO)—),
(ii) a compound represented by the general formula (1): 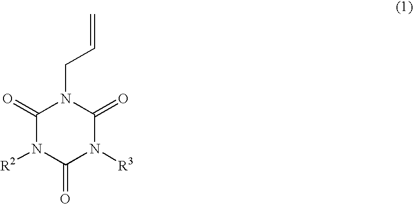
wherein each of R² and R³ independently represents an allyl group or a group represented by the general formula (2):
—CH₂CH₂CH₂—SiR⁴ₐ(OR⁵)₃₋ₐ (2)
where each of R⁴ and R⁵ independently represents an unsubstituted or substituted monovalent hydrocarbon group, and a represents an integer from 0 to 2, and
(iii) a compound represented by the general formula (3): 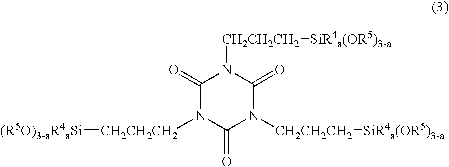
wherein R⁴, R⁵, and a are as defined for the general formula (2), and
(D) a curing agent.

2. The composition according to claim 1, wherein the component (i) of the component (C) is a compound represented by the general formula (4): 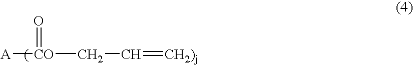
wherein A is a divalent to tetravalent group selected from the group consisting of —CH═CH—, —CH₂CH₂—, 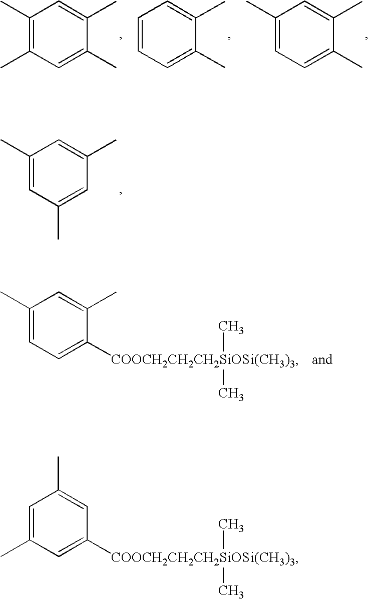
and j represents the valence number of the group A;
a compound represented by the general formula (5): 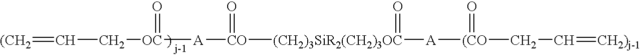
wherein each R independently represents an unsubstituted or substituted monovalent hydrocarbon group, and each of A and j is independently as defined for the general formula (4); or a combination of the compound represented by the general formula (4) and the compound represented by the general formula (5).

3. The composition according to claim 2, wherein the compound represented by the general formula (4) is a compound represented by the structural formula: 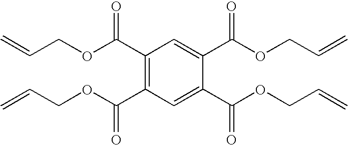
or a compound represented by the structural formula:

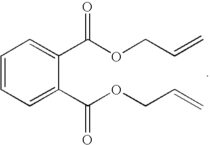

4. The composition according to claim 2, wherein the compound represented by the general formula (5) is a compound represented by the structural formula:

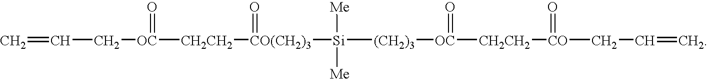

5. The composition according to claim 1, wherein the component (ii) of the component (C) is a compound represented by the structural formula: 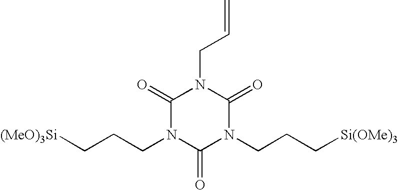
or a compound represented by the structural formula:

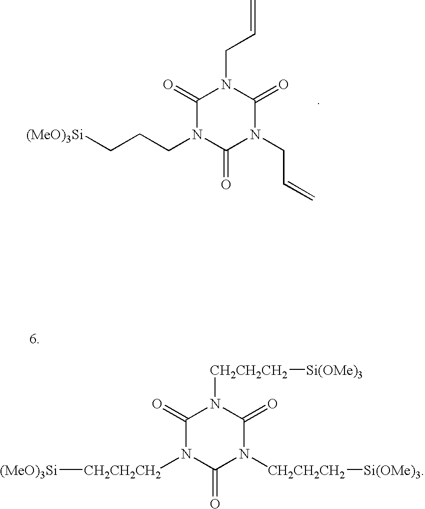

7. The composition according to claim 1, wherein the components (A) and (B) are present such that the weight ratio of the component (A)/the component (B) is 30/70 to 70/30, the component (C) is present in a quantity of 0.2 to 20 parts by weight based on 100 parts by weight of the combined quantity of the components (A) and (B), and the component (D) is present in an effective quantity as a curing agent.

8. A pressure-sensitive and heat-curable adhesive comprising the composition according to claim 1.

9. The adhesive according to claim 8, wherein the adhesive is in the form of a film.

10. The adhesive according to claim 9, further comprising a release film layered on one side or both sides of the adhesive.

11. A semiconductor device comprising a substrate and a semiconductor chip which is connected with the substrate through a cured layer of the adhesive according to claim 8.
